(19) United States
(12) Patent Application Publication
(10) Pub. No.: US 2021/0273306 A1
(43) Pub. Date: Sep. 2, 2021

(54) ENERGY STORAGE DEVICE

(71) Applicant: Dyson Technology Limited, Wiltshire (GB)

(72) Inventors: Joseph Daniel HOWARD, Swindon (GB); Michael Edward RENDALL, Newbury (GB)

(73) Assignee: Dyson Technology Limited, Wiltshire (GB)

(21) Appl. No.: 17/261,524

(22) PCT Filed: Jul. 19, 2019
(86) PCT No.: PCT/GB2019/052033

§ 371 Date: Jan. 19, 2021

(30) Foreign Application Priority Data
Jul. 20, 2018 (GB) 1811885.1

(51) Int. Cl. H01M 50/581; H01M 10/0525; H01G 11/86; H01G 11/16; H01G 9/00

(52) U.S. Cl. CPC H01M 50/581; H01M 10/0525; H01G 11/86; H01M 2200/103; H01G 9/0003; H01G 9/0029; H01G 11/16

(57) ABSTRACT

A thin-film energy storage device comprising a substrate; a first electrode comprising a fuse portion; a second electrode; an electrolyte between the first electrode and the second electrode; and an electrical connector, different from the first electrode, connected to the first electrode by the fuse portion.

### REFERENCE TO RELATED APPLICATIONS

This application is a national stage application under 35 U.S.C. 371 of International Application No. PCT/GB2019/052033, filed Jul. 19, 2019, which claims the priority of United Kingdom Application No. 1811885.1, filed Jul. 20, 2018, the entire contents of each of which are incorporated herein by reference.

### FIELD OF THE DISCLOSURE

The present disclosure relates to energy storage devices, intermediate structures for manufacture of energy storage devices and methods of manufacturing an energy storage device.

### BACKGROUND OF THE DISCLOSURE

Energy storage devices such as solid-state thin film cells are known. A thin-film battery typically includes a first electrode layer, a second electrode layer, and an electrolyte layer between the first electrode layer and the second electrode layer. A known thin-film battery is susceptible to failures, which can cause the battery to rise rapidly in temperature. This can lead to explosions. For example, the battery may be susceptible to short circuits between the first and second electrode layers or to overcharging.

It is desirable to provide an energy storage device that is safer or more reliable than an existing thin-film battery.

### SUMMARY OF THE DISCLOSURE

According to some embodiments of the present disclosure, there is provided a thin-film energy storage device comprising:

a substrate;

a first electrode comprising a fuse portion;

a second electrode;

an electrolyte between the first electrode and the second electrode; and

an electrical connector, different from the first electrode, connected to the first electrode by the fuse portion.

A fuse portion for example acts as an electrical safety device, which reduces the risk of thermal runaway. For example, such a fuse portion may be electrically conductive at a current below a predetermined threshold current (which may correspond with a temperature below a predetermined threshold temperature). However, above the predetermined threshold current or predetermined threshold temperature, the fuse portion may cease to conduct electricity. For example, the fuse portion may melt upon exposure to a current or temperature exceeding the predetermined threshold current or temperature, respectively. This may prevent the temperature rising further, which may in turn prevent thermal runaway from occurring. This typically improves the safety of the energy storage device. A fuse portion may be considered sacrificial in that it must be replaced or fixed after fusing has occurred.

For example, a defect in a layer of an energy storage device (such as a short circuit) may cause a rapid discharge of the layer. A single defect may therefore cause a discharge which propagates to other layers of a multi-layer cell of such an energy storage device. However, the fuse portion in the energy storage device according to examples herein may electrically isolate the first electrode from other layers of the energy storage device. Hence, if the first electrode includes a defect, the fuse portion may cease to be electrically conductive (for example, due to a rapid increase in temperature of the fuse portion, which may cause the fuse portion to melt). This may prevent current from flowing to other layers of the energy storage device, thereby electrically isolating the first electrode from the other layers. The other layers of the energy storage device may therefore be unaffected by the faulty layer (in this case, the first electrode). The other layers may therefore continue to function effectively. Hence, the safety and reliability of the energy storage device may be improved compared with other approaches in which individual layers are less effectively isolated from each other.

The fuse portion in these examples is for example an integrated fuse, which is part of a pre-existing component of the energy storage device (namely, the first electrode). Accordingly, the fuse portion may be provided straightforwardly, without increasing the complexity of the energy storage device.

In examples, the first electrode is closer to the substrate than the second electrode and the fuse portion is narrower than a portion of the first electrode overlapped by the second electrode, or the first electrode is further from the substrate than the second electrode and the fuse portion is narrower than a portion of the first electrode which overlaps the second electrode. In such examples, the fuse portion may therefore be a portion of the first electrode which is relatively thin, slim or otherwise narrow compared to a different portion of the first electrode. The relative thinness of the fuse portion for example causes the temperature of the fuse portion to rise more rapidly than a different portion of the first electrode upon exposure to a current exceeding a predetermined threshold current. This therefore causes the fuse portion to melt, and interrupt current flowing through the fuse portion to or from the first electrode.

By providing the fuse portion as a narrower portion of the first electrode, the fuse portion may be formed during formation of the first electrode. This can simplify the manufacture of the energy storage device, as the fuse portion can be provided without adding additional process steps to the manufacturing method. The first electrode may be closer to or further from the substrate than a second electrode. For example, the first electrode may be a cathode or an anode. Hence, either (or both) a cathode or an anode of the energy storage device may be provided with a fuse portion in a simple manner.

In some embodiments, the fuse portion is a protrusion of a first side of the first electrode. With such an arrangement, the fuse portion may be provided more straightforwardly than otherwise. For example, the fuse portion may be shaped during manufacture of the first electrode itself, without adding further processing. For example, the fuse portion may be formed during separation of a first electrode layer into a plurality of portions, with each portion corresponding to a first electrode for a cell of a multi-cell energy storage device, respectively.

In some embodiments, the protrusion (which for example corresponds to the fuse portion) protrudes in a direction substantially parallel to a plane of a surface of the substrate. The energy storage device in such examples is more compact than in other cases in which the protrusion of the fuse portion extends in a different direction. For example, a thickness of the energy storage device in a direction perpendicular to the plane of the substrate may be smaller than otherwise. This may therefore allow a larger number of cells to be included in an energy storage device of a predetermined thickness. Hence, the energy density of the energy storage device may be greater than otherwise.

In some embodiments, a first portion of the protrusion is narrower than a second portion of the protrusion further from the electrical connector than the first portion of the protrusion. In such cases, a contact area between the fuse portion and the electrical connector may correspond with a fusing area, at which fusing occurs if a predetermined threshold current is exceeded. For example, the first portion of the protrusion may be an end portion of the protrusion, which contacts the electrical connector. The protrusion may therefore narrow or otherwise decrease in width towards the protrusion. This may therefore provide a relatively small area of contact between the fuse portion and the electrical connector at which fusing may occur. In other examples, though, the protrusion may not progressively or gradually decrease in width towards the protrusion. Nevertheless, the first portion of the protrusion may be narrower than the second portion of the protrusion. By providing a narrower portion of the protrusion (as the first portion, for example), the narrower portion of the protrusion provides a region of the protrusion which melts when exposed to too high a current. This therefore provides the desired fusing effect. A shape, size or other feature of the first portion of the protrusion may be controlled to provide the first electrode with a fuse portion of a predetermined fuse rating.

In some embodiments, the electrical connector contacts the fuse portion without contacting an indented portion of the first side of the first electrode. Fusing may occur at a contact area between the fuse portion and the electrical connector (for example where the fuse portion is narrowest where it contacts the electrical connector). During manufacture of the energy storage device, a size of the contact area may be controlled to control an internal resistance of the first electrode. In turn, this may control the current the first electrode can carry before reaching a sufficiently high temperature for melting of the fuse portion, and fusing, to occur. In this way, an appropriate fuse rating for the fuse portion can be obtained, so that the energy storage device operates effectively and safely.

In some embodiments, the indented portion of the first side of the first electrode is substantially C-shaped, substantially V-shaped, or substantially elongate in plan view. In other words, various different shapes may be used to provide a fuse portion of the first electrode. The shape selected may depend on an intended use of the energy storage device, such as whether the energy storage device is intended to be used in relatively high or relatively low power applications. First electrodes with different shaped fuse portions may therefore be provided, for example to provide fuse portions of different fuse ratings.

In some embodiments, a side of the electrical connector comprises an electrical connector fuse portion in contact with the fuse portion of the first electrode and a further portion not in contact with the first electrode. For example, the further portion of the electrical connector may be indented or otherwise recessed compared to the electrical connector fuse portion. The electrical connector fuse portion may be a protrusion of the side of the electrical connector. In these examples, the electrical connector fuse portion and the fuse portion of the electrode layer may together provide or otherwise correspond with a combined fuse portion. A fuse rating of the combined fuse portion may be controlled by controlling features of the fuse portion of the electrode layer and/or the electrical connector fuse portion, such as its width, length or shape.

In some embodiments, a second side of the first electrode, opposite to the first side, is substantially planar. For example, a sufficient fusing capability may be provided by providing the fuse portion on one side of the first electrode. The other side of the first electrode (e.g. the second side) may hence be planar. This may further simplify manufacture of the energy storage device.

In some embodiments, the thin-film energy storage device comprises a further first electrode comprising a further fuse portion, the further first electrode overlapping the first electrode. In these examples, the electrical connector is connected to the further first electrode by the further fuse portion. In this way, a multi-cell energy storage device may be provided. As the further first electrode in these examples includes the further fuse portion, fusing of the further first electrode may occur independently of fusing of the first electrode. Hence, if the fuse portion of the first electrode melts, for example if the first electrode is defective, the further first electrode may nevertheless continue to operate effectively. In this way, the fuse portion of the first electrode electrically isolates the first electrode from the further first electrode. The further first electrode may itself be protected from excessively high currents due to the further fuse portion. For example, the further fuse portion may, in due course, also melt if the further first electrode is subjected to a current that exceeds a predetermined threshold current. This improves the effectiveness of the energy storage device, by increasing the number of cells (or layers) that continue to operate in the event of a defect in a cell or layer of the energy storage device.

In some embodiments, the fuse portion is a first fuse portion, the electrical connector is a first electrical connector, the second electrode comprises a second fuse portion, and the thin-film energy storage device comprises a second electrical connector connected to the second electrode by the second fuse portion. The second fuse portion may be similar to the first fuse portion, but be formed as part of the second electrode rather than the first electrode. The second fuse portion may therefore become electrically non-conductive, for example by melting, if subjected to a current which exceeds a predetermined threshold current. Melting of the second fuse portion, for example, electrically isolates the second electrode from other layers of the energy storage device. In this way, fusing of the first fuse portion of the first electrode may not affect the second electrode, which may continue to operate. Similarly, fusing of the second fuse portion of the second electrode may not affect the first electrode.

In some embodiments, the thin-film energy storage device comprises a stack comprising the first electrode, the second electrode and the electrolyte. In these examples, the first electrical connector extends along a first side of the stack and the second electrical connector extends along a second side of the stack, opposite to the first side of the stack. The first and second electrical connectors may therefore be electrically isolated from each other. This allows multiple cells to be connected in parallel with each other. This can improve the energy storage capacity of the energy storage device. In such cases, the first electrode is connected to the first electrical connector via the first fuse portion and the second electrode is connected to the second electrical connector via the second fuse portion. Hence, if there is a defect in the first or second electrodes, the first or second fuse portions may become electrically non-conductive, preventing current from flowing to other first or second electrodes, e.g. via the first or second electrical connectors. In this way, the other first or second electrodes may continue to function effectively, while the defect is contained within the layer in which it originates (e.g. the first or second electrode).

In some embodiments, the first electrode comprises a plurality of fuse portions each having substantially the same shape as each other, the plurality of fuse portions comprising the fuse portion. The number and shape of the fuse portions may be selected to provide a particular fuse rating of the plurality of fuse portions. It may be more straightforward to accurately control the fuse rating by controlling the number and shape of the fuse portions rather than by attempting to accurately control the shape or size of a single fuse portion. This may allow the energy storage device to be manufactured with a wider range of different fuse ratings.

According to some embodiments of the present disclosure, there is provided a method comprising:

providing a stack for a thin-film energy storage device, the stack comprising an electrode layer;

removing a first portion of the electrode layer corresponding to a first region of the electrode layer, using at least one first pulse of a laser beam, a first shape of the first portion at least partly corresponding to a first cross-section of the laser beam during the at least one first pulse; and

removing a second portion of the electrode layer corresponding to a second region of the electrode layer, using at least one second pulse of the laser beam, a second shape of the second portion at least partly corresponding to a second cross-section of the laser beam during the at least one second pulse, the second region of the electrode layer displaced from the first region of the electrode layer to leave a remaining portion of the electrode layer at least partly between the first region of the electrode layer and the second region of the electrode layer as a fuse portion of the electrode layer.

In some embodiments in accordance with some embodiments of the present disclosure, the removal of the first and second portions of the electrode layer is used to manufacture the fuse portion of the electrode layer. Manufacture of an energy storage device may include removal of portions of the electrode layer in order to provide a channel into which an electrically insulating material may be deposited to insulate the electrode layer from other portions of the stack, such as a further electrode layer. For example, by forming the channel, the electrode layer may be separated into a plurality of portions, each corresponding with a different respective cell of a multi-cell energy storage device. The electrically insulating material may be deposited between neighbouring cells.

In such cases, the removal of the first and second portions of the electrode layer may be performed during formation of the channel in the electrode layer. This allows the fuse portion to be manufactured during existing processing for the manufacture of the energy storage device. In other words, the fuse portion can be provided without adding in further process steps to the manufacturing process. The fuse portion can therefore be provided straightforwardly, without increasing complexity in the manufacturing method. In addition, the shape of the first and second portions of the electrode layer, which are removed, can be controlled straightforwardly by controlling a cross-section of the laser beam during application of the at least one first and second pulse. This allows the shape of the fuse portion to be controlled in an accurate and easy manner.

In some embodiments, methods in accordance with some embodiments may further include:

arranging an electrical connector in contact with the electrode layer;

removing a first portion of the electrical connector corresponding to a first region of the electrical connector, using the at least one first pulse of the laser beam, during removing the first portion of the electrode layer; and

removing a second portion of the electrical connector corresponding to a second region of the electrical connector, using the at least one second pulse of the laser beam, during removing the second portion of the electrode layer, the second region of the electrical connector displaced from the first region of the electrical connector to leave a remaining portion of the electrical connector at least partly between the first region of the electrical connector and the second region of the electrical connector,

wherein the remaining portion of the electrical connector is in contact with the fuse portion of the electrode layer.

In these examples, the remaining portion of the electrical connector may act as an electrical connector fuse portion. The electrical connector fuse portion and the fuse portion of the electrode layer may together provide or otherwise correspond with a combined fuse portion. A fuse rating of the combined fuse portion may be controlled by controlling formation of the fuse portion of the electrode layer and/or the electrical connector fuse portion, to provide these portions with predetermined features, such as a predetermined width, length and/or shape to provide a given fuse rating.

A plurality of cells can be manufactured on the same substrate and subsequently separated, for example by cutting the stack. This allows a plurality of cells to be formed efficiently, for example using a roll-to-roll manufacturing technique. In such cases, the electrical connector may be provided along a side of the stack, for example after the stack has been cut into individual cell portions. The first and second portions of the electrode layer and the electrical connector may then be removed. By using the at least one first pulse to remove the first portions of both the electrode layer and the electrical connector, the method may be more efficient than other methods in which these portions are removed at different times, for example in different process steps. The efficiency may be further improved by removing the second portions of both the electrode layer and the electrical connector using the at least one second pulse.

In some embodiments, the electrical connector comprises a different material than the electrode layer. This may provide further flexibility for the manufacturing process, by allowing the electrical connector and the electrode layer to be deposited using different processes or at different times from each other. Furthermore, an effectiveness of the energy storage device may be increased by selecting materials for the electrical connector and the electrode layer that are appropriate for their respective functions.

In some embodiments, after removing the first portion of the electrode layer and the second portion of the electrode layer, the electrode layer comprises a first perforation corresponding to the first region of the electrode layer, and a second perforation corresponding to the second region of the electrode layer. The first and second perforations for example correspond with holes in the electrode layer, which may pass partly or entirely through the electrode layer. The remaining portion of the electrode layer for example separates the first perforation from the second perforation. Hence, by controlling the laser beam during formation of the first and second perforations, the shape and size of the fuse portion can also be controlled. This allows the fuse portion to be provided with a particular fuse rating.

In some embodiments, the first perforation and the second perforation are at least one of: substantially the same size as each other, or substantially the same shape as each other. This may simplify manufacture. For example, various characteristics or parameters of the laser beam may remain unchanged between formation of the first perforation (e.g. using the at least one first pulse) and formation of the second perforation (e.g. using the at least one second pulse). Instead, the laser beam and the stack may be moved relative to each other during provision of the at least one first and second pulses, without altering other features of the laser beam.

In some embodiments, the method includes controlling the laser beam to form the first perforation and the second perforation each with least one of: a predetermined size or a predetermined pitch. By controlling the size or pitch of the first and second perforations, a corresponding size or pitch of the fuse portion may also be controlled. This allows the fuse portion to be manufactured with a particular size or pitch. In this way, the fuse portion may be manufactured with a predetermined fuse rating.

In some embodiments, the remaining portion of the electrode layer is a first remaining portion, the fuse portion is a first fuse portion, and the method comprises: removing a third portion of the electrode layer corresponding to a third region of the electrode layer, using at least one third pulse of the laser beam, a third shape of the third portion at least partly corresponding to a third cross-section of the laser beam during the at least one third pulse, the third region displaced from the second region to leave a second remaining portion at least partly between the second region and the third region as a second fuse portion of the electrode layer. In this way, a plurality of fuse portions of the electrode layer may be provided. By controlling the number and shape of the fuse portions, the fusing properties of the electrode layer may be controlled straightforwardly.

In some embodiments, the electrode layer comprises a first section and a second section, the first region of the electrode layer between the first section and the second section, and the second region of the electrode layer between the first section and the second section. In these examples, the fuse portion of the electrode layer connects the first section of the electrode layer to the second section of the electrode layer. This may reduce the amount of the electrode layer which is removed during formation of the fuse portion. This may improve the efficiency of the manufacturing process, and reduce wastage of the material of the electrode layer.

In some embodiments, the electrode layer comprises a first section and a second section, the first region between the first section and the second section, and the second region between the first section and the second section. In these examples, a length of the fuse portion of the electrode layer is less than a distance between the first section and the second section such that the first section of the electrode layer is not connected to the second section of the electrode layer by the fuse portion. This for example allows a greater separation between the first and second sections of the electrode layer to be provided. This may simplify the deposition of an electrically insulating material to insulate the electrode layer from other layers of the stack. For example, the electrically insulating material may be deposited in an elongate channel between the first and second sections of the electrode layer. This may be more straightforward than in other cases in which the fuse portion connects the first and second sections of the electrode layer to each other (and in which the electrically insulating material may be deposited within separate first and second channels formed by removal of the first and second portions of the electrode layer).

In some embodiments, the stack is on a substrate, and the method comprises cutting through the stack in a direction substantially perpendicular to a plane of a surface of the substrate to provide an intermediate structure for manufacture of the thin-film energy storage device. In such examples, a plurality of cells can be manufactured on the same substrate and subsequently separated, for example by cutting the stack. This allows a plurality of cells to be formed efficiently, for example using a roll-to-roll manufacturing technique.

In these examples, the intermediate structure comprises a portion of the substrate, and an electrode formed from the electrode layer. The electrode comprises the fuse portion as a protrusion of a side of the electrode and the protrusion protrudes in a direction substantially parallel to a plane of a surface of the portion of the substrate. The energy storage device in such examples is more compact than in other cases in which the protrusion of the fuse portion extends in a different direction.

In some embodiments, the fuse portion narrows in shape. Such a shape for example allows the fuse portion to act as a fuse. For example, a narrower part of the fuse portion may tend to melt more readily than other parts of the fuse portion (or other parts of the electrode layer), allowing current flow to be interrupted when the current exceeds a predetermined threshold current.

In some embodiments, the stack is on a first side of a substrate and the laser beam is directed towards the first side of the substrate during the at least one first pulse and the at least one second pulse. This may simplify the removal of the first and second portions of the electrode layer compared to other cases in which there are laser beams on both sides of the stack or in which the laser beam is moved from the first side to a different side in between removal of the first portion and the second portion of the electrode layer.

In some embodiments, the method comprises moving one of the laser beam and the electrode layer relative to the other of the laser beam and the electrode layer after applying the at least one first laser pulse of the laser beam to the electrode layer and before applying the at least one second laser pulse of the laser beam to the electrode layer. In this way, the fuse portion can be generated in a particular position, and with a given shape and/or size, by moving the laser beam and the electrode layer relative to each other. This may be more straightforward than other ways of controlling features of the fuse portion during manufacture.

In some embodiments, the first cross-section of the laser beam overlaps a first region of the stack during the at least one first pulse, and the second cross-section of the laser beam overlaps a second region of the stack during the at least one second pulse, the second region of the stack partly overlapping the first region of the stack. In such examples, the laser spot of the laser beam may not be entirely overlapping during removal of the first and second portions of the electrode layer. An extent of overlap of the first and second regions of the stack (overlapped by the first and second cross-sections of the laser beam) may be controlled to controlled various features of the fuse portion, which in turn may be used to control a fuse rating of the fuse portion in a straightforward manner.

In some embodiments, the method comprises determining a pulse timing scheme for using the at least one first pulse of the laser beam for removing the first portion of the electrode layer and the at least one second pulse of the laser beam for removing the second portion of the electrode layer, without removing the remaining portion of the electrode layer. In these examples, the method may further comprise controlling a timing of the at least one first pulse of the laser beam and the at least one second pulse of the laser beam in accordance with the pulse timing scheme. In this way, the at least one first and second pulses can be applied at appropriate times to produce a fuse portion with a given shape and/or size. This allows the fuse portion to be manufactured simply, and with particular properties.

In some embodiments, the method comprises controlling the laser beam to remove the first portion of the electrode layer and the second portion of the electrode layer so that the fuse portion has a predetermined fuse rating. The fuse rating may be selected based on the intended use of the energy storage device. This allows the method to be adapted to manufacture various different energy storage devices, with different intended uses. Accordingly, the method may be more flexible than other methods, which may be suitable for manufacturing energy storage devices with a more limited range of applications.

Further features will become apparent from the following description, given by way of example only, which is made with reference to the accompanying drawings.

### BRIEF DESCRIPTION OF THE FIGURES

FIG. 1 is a schematic diagram that shows a stack for an energy storage device according to some embodiments;

FIG. 2 is a schematic diagram that shows an example of processing the stack of FIG. 1 for manufacture of an energy storage device according to some embodiments;

FIG. 3 is a schematic diagram that shows a portion of an energy storage device formed from the stack of FIG. 1, in plan view along the line A-A′ in FIG. 1;

FIG. 4 is a schematic diagram that shows, in plan view, a portion of an energy storage device according to further examples;

FIG. 5 is a schematic diagram that shows, in plan view, a portion of an energy storage device according to yet further examples;

FIG. 6 is a schematic diagram that shows, in cross-section, a portion of an energy storage device according to some embodiments;

FIG. 7 is a schematic diagram that shows, in plan view, a portion of an energy storage device according to still further examples;

FIG. 8 is a schematic diagram that shows, in cross-section, removal of a portion of an electrode layer according to some embodiments;

FIG. 9 is a schematic diagram that shows removal of portions of the electrode layer of FIG. 8, in plan view, according to some embodiments;

FIG. 10 is a schematic diagram that shows removal of portions of the electrode layer, in plan view, according to some embodiments;

FIG. 11 is a schematic diagram that shows, in plan view, further processing that may be applied to the stack of FIG. 9;

FIG. 12 is a schematic diagram that shows, in plan view, the stack of FIG. 9 after the further processing of FIG. 11;

FIG. 13 is a schematic diagram that shows the stack of FIG. 12 in cross-section, along the line B-B′ in FIG. 12; and

FIG. 14 is a schematic diagram that shows removal of portions of an electrode layer in plan view, according to some embodiments.

### DETAILED DESCRIPTION OF THE DISCLOSURE

Details of methods, structures and devices according to examples/embodiments will become apparent from the following description, with reference to the Figures. In this description, for the purpose of explanation, numerous specific details of certain examples/embodiments are set forth. Reference in the specification to “an example,” “an embodiment” or similar language means that a particular feature, structure, or characteristic described in connection with the example/embodiment is included in at least that one example/embodiment, but not necessarily in other examples/embodiments. It should further be noted that certain examples/embodiments are described schematically with certain features omitted and/or necessarily simplified for ease of explanation and understanding of the concepts underlying the examples/embodiments.

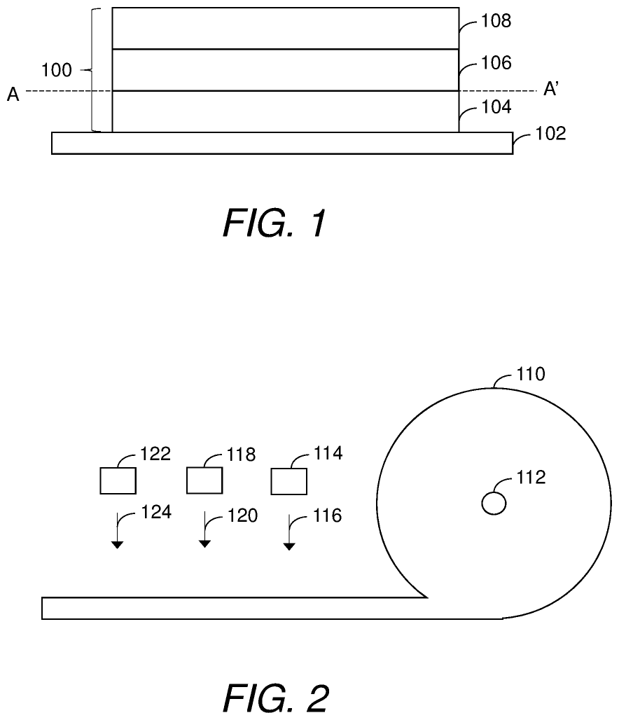

FIG. 1 shows a stack 100 of layers for an energy storage device. The stack 100 of FIG. 1 may be used as part of a thin-film energy storage device having a solid electrolyte, for example.

The stack 100 is on a substrate 102 in FIG. 1. The substrate 102 is for example glass or polymer and may be rigid or flexible. The substrate 102 is typically planar. Although the stack 100 is shown as directly contacting the substrate 102 in FIG. 1, there may be one or more further layers between the stack 100 and the substrate 102 in other examples. Hence, unless otherwise indicated, reference herein to an element being “on” another element is to be understood as including direct or indirect contact. In other words, an element on another element may be either touching the other element, or not in contact the other element but, instead, generally supported by an intervening element (or elements) but nevertheless located above, or overlapping, the other element.

The stack 100 of FIG. 1 includes a first electrode layer 104, an electrolyte layer 106 and a second electrode layer 108. In the example of FIG. 1, the second electrode layer 108 is further from the substrate 102 than the first electrode layer 104, and the electrolyte layer 106 is between the first electrode layer 104 and the second electrode layer 108.

The first electrode layer 104 may act as a positive current collector layer. In such embodiments, the first electrode layer 104 may form a positive electrode layer (which may correspond with a cathode during discharge of a cell of the energy storage device including the stack 100). The first electrode layer 104 may include a material which is suitable for storing lithium ions by virtue of stable chemical reactions, such as lithium cobalt oxide, lithium iron phosphate or alkali metal polysulphide salts.

In alternative embodiments, there may be a separate positive current collector layer, which may be located between the first electrode layer 104 and the substrate 102. In these embodiments, the separate positive current collector layer may include nickel foil, but it is to be appreciated that any suitable metal could be used, such as aluminium, copper or steel, or a metalised material including metalised plastics such as aluminium on polyethylene terephthalate (PET).

The second electrode layer 108 may act as a negative current collector layer. The second electrode layer 108 in such cases may form a negative electrode layer (which may correspond with an anode during discharge of a cell of an energy storage device including the stack 100). The second electrode layer 108 may include a lithium metal, graphite, silicon or indium tin oxide (ITO). As for the first electrode layer 104, in other embodiments, the stack 100 may include a separate negative current collector layer, which may be on the second electrode layer 108, with the second electrode layer 108 between the negative current collector layer and the substrate 102. In some embodiments in which the negative current collector layer is a separate layer, the negative current collector layer may include nickel foil. It is to be appreciated, though, that any suitable metal could be used for the negative current collector layer, such as aluminium, copper or steel, or a metalised material including metalised plastics such as aluminium on polyethylene terephthalate (PET).

The first and second electrode layers 104, 108 are typically electrically conductive. Electrical current may therefore flow through the first and second electrode layers 104, 108 due to the flow of ions or electrons through the first and second electrode layers 104, 108.

The electrolyte layer 106 may include any suitable material which is ionically conductive, but which is also an electrical insulator, such as lithium phosphorous oxynitride (LiPON). As explained above, the electrolyte layer 106 is for example a solid layer, and may be referred to as a fast ion conductor. A solid electrolyte layer may have structure which is intermediate between that of a liquid electrolyte, which for example lacks a regular structure and includes ions which may move freely, and that of a crystalline solid. A crystalline material for example has a regular structure, with an ordered arrangement of atoms, which may be arranged as a two dimensional or three dimensional lattice. Ions of a crystalline material are typically immobile and may therefore be unable to move freely throughout the material.

The stack 100 may for example be manufactured by depositing the first electrode layer 104 on the substrate 102. The electrolyte layer 106 is subsequently deposited on the first electrode layer 104, and the second electrode layer 108 is then deposited on the electrolyte layer 106. Each layer of the stack 100 may be deposited by flood deposition, which provides a simple and effective way of producing a highly homogenous layer, although other deposition methods are possible.

The stack 100 of FIG. 1 may undergo further processing to manufacture an energy storage device. An example of processing that may be applied to the stack 100 of FIG. 1 is illustrated schematically in FIG. 2.

In FIG. 2, the stack 100 and the substrate 102 together form an intermediate structure 110 for the manufacture of an energy storage device. The intermediate structure 110 in this example is flexible, allowing it to be wound around a roller 112 as part of a roll-to-roll manufacturing process (sometimes referred to as a reel-to-reel manufacturing process). The intermediate structure 110 may be gradually unwound from the roller 112 and subjected to further processing.

In the example of FIG. 2, grooves may be formed through the intermediate structure 110 (for example through the stack 100) using a first laser 114. The first laser 114 is arranged to apply laser beams 116 to the intermediate structure 110 to remove portions of the intermediate structure, thereby forming grooves in the stack 100. This process may be referred to as laser ablation.

After formation of the grooves, electrically insulating material may be deposited in at least some of the grooves using a material deposition system 118. The material deposition system 118 for example fills at least some of the grooves with a liquid 120 such as an organic suspended liquid material. The liquid 120 may then be cured in the grooves to form electrically insulating plugs in the grooves. An electrically insulating material may be considered to be electrically non-conductive and may therefore conduct a relatively a small amount of electric current when subjected to an electric field. Typically, an electrically insulating material (sometimes referred to as an insulator) conducts less electric current than semiconducting materials or electrically conductive materials. However, a small amount of electric current may nevertheless flow through an electrically insulating material under the influence of an electric field, as even an insulator may include a small amount of charge carriers for carrying electric current. In some embodiments herein, a material may be considered to be electrically insulating where it is sufficiently electrically insulating to perform the function of an insulator. This function may be performed for example where the material insulates one element from another sufficiently for short circuits to be avoided.

Referring to FIG. 2, after deposition of the electrically insulating material, the intermediate structure 110 is cut along at least some of the grooves to form separate cells for an energy storage device. In some embodiments such as FIG. 2, hundreds and potentially thousands of cells can be cut from a roll of the intermediate structure 110, allowing multiple cells to be manufactured in an efficient manner.

In FIG. 2, the cutting operation is performed using a second laser 122, which is arranged to apply laser beams 124 to the intermediate structure 110. Each cut may for example be through the centre of an insulating plug such that the plug is split into two pieces, each piece forming a protective covering over exposed surfaces including edges to which it has attached. Cutting through the entire stack in this way creates exposed surfaces of the first and second electrode layers 104, 108.

Although not shown in FIG. 2 (which is merely schematic), it is to be appreciated that, after deposition of the electrically insulating material, the intermediate structure 110 may be folded back on itself, to create a z-fold arrangement having at least ten, possibly hundreds, and potentially thousands, of layers with each of the insulating plugs aligned. The laser cutting process performed by the second laser 122 may then be used to cut through the z-fold arrangement in a single cutting operation for each of the aligned sets of plugs.

After cutting the cells, electrical connectors can be provided along opposite sides of a cell, such that a first electrical connector on one side of the cell contacts the first electrode layer 104 (which may be considered to form a first electrode after the cell has been separated from the remainder of the intermediate structure 110), but is prevented from contacting the other layers by the electrically insulating material. Similarly, a second electrical connector on an opposite side of the cell can be arranged in contact with the second electrode layer 108 (which may be considered to form a second electrode after the cell has been separated from the remainder of the intermediate structure 110), but is prevented from contacting the other layers by the insulating material. The insulating material may therefore reduce the risk of a short circuit between the first and second electrode layers 104, 108 and the other layers in each cell. The first and second electrical connectors may, for example, be a metallic material that is applied to the edges of the stack (or to the edges of the intermediate structure 110) by sputtering. The cells can therefore be joined in parallel simply and easily.

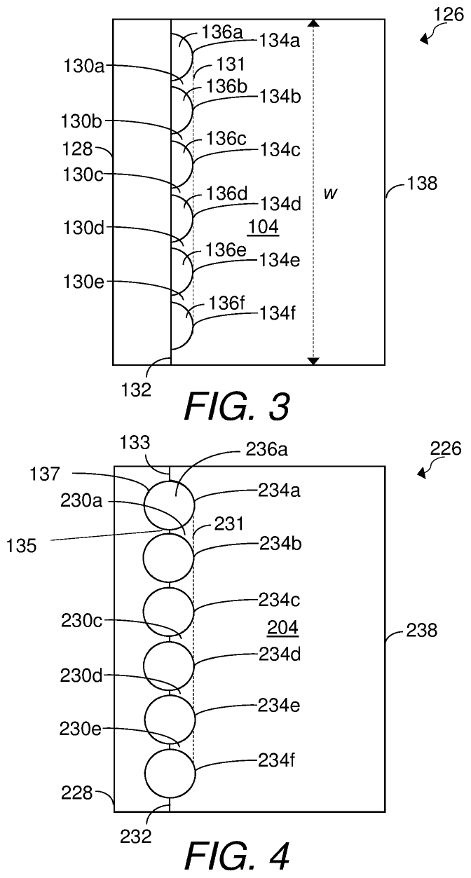

FIG. 3 is a schematic diagram that shows a portion of an example of an energy storage device 126. The energy storage device 126 includes the stack 100 of FIG. 1. However, the energy storage device 126 has undergone further processing compared to FIG. 1, to separate the stack 100 into individual cells, and to deposit an electrical connector 128. FIG. 3 shows the stack 100 of FIG. 1 in plan view, along the line A-A′. In other words, FIG. 3 corresponds to a slice taken through the stack 100 of FIG. 1 along the line A-A′. The line A-A′ of FIG. 1 corresponds with an upper surface of the first electrode 104. Hence, in FIG. 3, the first electrode 104 is visible, whereas the electrolyte layer 106 and the second electrode 108 are not. Layers beneath the first electrode 104 are obscured in FIG. 3. Features of FIG. 3 which are similar to corresponding features of FIG. 1 are labelled with the same reference numeral. Corresponding descriptions are to be taken to apply.

The energy storage device 126 of FIG. 3 is a thin-film energy storage device. A thin-film energy storage device typically includes a series of thin layers, with a thickness of the order of a few micrometres or less. Thin-film energy storage devices may be solid-state batteries, with a solid electrolyte. Solid electrolytes may occupy a smaller volume within a cell of an energy storage device than a liquid electrolyte, and thereby may provide improved energy density. Thin-film energy storage devices may be relatively flexible and may therefore be formed using roll-to-roll processing techniques, which are highly scalable.

The energy storage device 126 includes the first electrode 104, the second electrode 108 and the electrolyte 106 between the first and second electrodes 104, 108. The first electrode 104 includes a fuse portion 130a. In FIG. 3, the first portion 130a of the first electrode 104 extends inwardly from a first side 132 of the first electrode 104, by a relatively small distance compared to the width of the first electrode, to a region of the first electrode indicated by a dashed line 131, which is included in the Figure merely for illustrative purposes. The electrical connector 128, which is different from the first electrode 104, is connected to the first electrode 104 by the fuse portion 130a. An electrical connector 128 may be considered to be different from the first electrode 104 where the electrical connector 128 and the first electrode 104 are manufactured from, or include, different materials. For example, the electrical connector 128 may be or include a conductive ink, a conductive paste or solder. In other embodiments, the electrical connector 128 and the first electrode 104 may be made from the same material but may be deposited at different times, respectively, such as during different steps of a multi-step manufacturing process. For example, the first electrode 104 may be formed by depositing a first electrode layer and subsequently separating the first electrode layer into multiple portions, each corresponding to a respective first electrode. After this separation, the electrical connector 128 (which may include the same or a different material than the first electrode 104) may be deposited to contact or otherwise connect to the first electrode 104. In some embodiments herein, the electrical connector 128 is connected to the first electrode 104 by the fuse portion 130a. This may be the case where the electrical connector 128 contacts the fuse portion 130a. However, the electrical connector 128 may also contact other portions of the first electrode 104.

The fuse portion 130a may be any portion of the first electrode 104 with a characteristic (such as a shape and/or size) that is appropriate for the fuse portion 130a to act as a fuse. The fuse portion 130a may therefore allow current to flow between the first electrode 104 and the electrical connector 128 up to a particular predetermined threshold current, which is below a threshold current that may otherwise flow through the bulk of the electrode. However, above this threshold current, the temperature of the fuse portion 130a may rise (for example due to an intrinsic resistance of the fuse portion 130a) sufficiently that the fuse portion 130a melts and prevents current from flowing between the first electrode 104 and the electrical connector 128.

The fuse portion 130a in FIG. 3 is a narrower portion of the first electrode 104 than another portion of the first electrode 104. In FIG. 3, the first electrode 104 is closer to the substrate 102 than the second electrode 108 (not shown in FIG. 3), and the fuse portion 130a is narrower than a portion of the first electrode 104 overlapped by the second electrode 108. The width w of the portion of the first electrode 104 overlapped by the second electrode is labelled in FIG. 3. As can be seen, this is much larger than a width of the fuse portion 130a in the same direction. For example, the fuse portion 130a may be narrower than the portion of the first electrode 104 overlapped by the second electrode in a plane parallel to a plane of a surface of the first electrode 104 (or a plane parallel to a plane of a surface of the substrate 102).

In order to provide a fuse portion 130a as a narrower portion of the first electrode 104, for connection to the electrical connector 128, the fuse portion 130a may be a protrusion of a first side 132 of the first electrode 104. FIG. 3 shows such an example. In this context, a fuse portion may be considered to be a protrusion where it protrudes, projects, or juts outwards from an inner portion of the first electrode 104. Such a protrusion may protrude in a direction substantially parallel to a plane of a surface of the substrate, as shown in FIG. 3. A direction may be considered substantially parallel to a plane where the direction is exactly parallel to the plane or where the direction is parallel to the plane within measurement uncertainties, such as within 20%, 15%, 10%, 5% or less. In such cases, the first electrode 104 may have a substantially planar or flat surface, such as a surface which is flat within manufacturing tolerances, or with height variations of less than 20%, 15%, 10%, 5% or less of a thickness of the first electrode 104 in a direction perpendicular to the surface. Nevertheless, the fuse portion 130a may extend in an outwards direction, in the plane of the surface, away from a centre of the first electrode 104.

The fuse portion 130a may have a variety of different shapes. In FIG. 3, a narrowest part of the fuse portion 130a contacts the electrical connector 128. However, in other embodiments, the fuse portion 130a may widen before contacting the electrical connector 128. In FIG. 3, the fuse portion 130a narrows gradually towards the electrical connector 128. However, in other cases, the fuse portion 130a may instead merely have a first portion which is narrower than a second portion. For example, the second portion may be further from the electrical connector 128 than the first portion.

In the example of FIG. 3, the electrical connector 128 contacts the fuse portion 130a without contacting an indented portion 134a of the first side 132 of the first electrode 104. An indented portion is for example a recessed portion of the first side 132 of the first electrode 104, which is set back, cut away or otherwise receded from the fuse portion 130a. For example, the fuse portion 130a may be considered to protrude relative to the indented portion 134, or the indented portion 134 may be considered to be recessed relative to the fuse portion 130a. With this arrangement, there is for example a gap 136a between the indented portion 134a of the first electrode 104 and the electrical connector 128. In FIG. 3, the gap 136a is empty, and does not include another element or component of the energy storage device 126. However, in other examples, such a gap may include another element, such as an electrical insulating material to insulate the indented portion 134a of the first electrode 104 from the electrical connector 128.

With the arrangement of FIG. 3, contact between the electrical connector 128 occurs at the fuse portion 130a. However, as can be seen from FIG. 3, the electrical connector 128 need not contact an entirety of the fuse portion 130a (although it may do). In FIG. 3, the electrical connector 128 merely contacts an end portion of the fuse portion 130a, although in other examples, the electrical connector 128 may contact a different portion of the fuse portion 130a instead or as well. There is, however, no contact between the electrical connector 128 and the indented portion 134a. Due to the lack of contact between the electrical connector 128 and the indented portion 134a, there is for example a smaller contact area between the electrical connector 128 and the first electrode 104 than otherwise. This may increase the interfacial resistance between the electrical connector 128 and the fuse portion 130a for a given level of current flow. This may therefore make the fuse portion 130a more sensitive to increases in current. For example, the temperature of the fuse portion 130a may rise more rapidly than with a larger contact area between the electrical connector 128 and the first electrode 104. Hence, such an energy storage device 126 may be more suitable for lower power applications than higher power applications. Moreover, the energy storage device 126 may provide more protection from the effects of high current, which may be useful in situations in which other components are relatively delicate and easily damaged by high currents.

The indented portion 134a may have various different shapes, depending on an intended use of the energy storage device 126. In FIG. 3, the indented portion 134a is substantially C-shaped in plan view. However, in other examples, the indented portion may be substantially V-shape or elongate (such as a slit or slot) in plan view, although other shapes are possible. A shape may be considered to be substantially C-shaped where it is an exact or precise C-shape or where it is merely generally recognisable as a C-shape. Similarly, a shape may be considered to be substantially V-shaped where it is exactly V-shape or where it is generally recognisable as a V-shape.

A second side 138 of the first electrode 104, opposite to the first side 132, may be substantially planar. A substantially planar side of an electrode is for example flat within manufacturing tolerances, or with height variations of less than 20%, 15%, 10%, 5% or less of a thickness of the electrode in a direction perpendicular to a surface of the side. FIG. 3 shows such an example.

In some embodiments such as FIG. 3, there may be a plurality of fuse portions (although there may instead be solely one fuse portion). The fuse portions are labelled with reference numerals 130a-130e in FIG. 3, collectively referred to as 130. The fuse portions 130 in such cases may correspond with a series of contact areas between the electrical connector 128 and the first electrode 104. The quantity, shape and/or size of the fuse portions 130 may be controlled to control a fuse rating. Similarly, there are also a plurality of indented portions, labelled with reference numerals 134a-134f (collectively referred to as 134), and a plurality of gaps, labelled with reference numerals 136a-136f (collectively referred to as 136).

Where there are a plurality of fuse portions 130, the plurality of fuse portions 130 may provide the first electrode 104 with a patterned or otherwise non-planar or non-straight first side 132. This is shown in FIG. 3, in which the first side 132 of the first electrode 104 is scalloped due to the fuse portions 130. In such cases, each of the fuse portions 130 may be substantially the same shape as each other, which may simplify manufacture. However, in other cases, some of the fuse portions 130 may have different shapes and/or sizes than others. In such cases, some of the indented portions 134 may have different shapes and/or sizes than others and some of the gaps 136a-136f may have different shapes and/or sizes than others. In such cases, a fuse rating of each the fuse portions 130 may nevertheless be the same as each other.

FIG. 4 shows a portion of an energy storage device 226. The energy storage device 226 of FIG. 4 is similar to that of FIG. 3. Similar features are labelled with the same reference numeral in FIG. 4 as in FIG. 3, but incremented by 100; corresponding descriptions are to be taken to apply.

In FIG. 4, both the electrical connector 228 and the first electrode 204 have a non-planar side. In this example, a side 133 of the electrical connector 228 (which is for example a closest side of the electrical connector 228 to the fuse portion 230a of the first electrode 204) has an electrical connector fuse portion 135 in contact with the fuse portion 230a of the first electrode 204. In other embodiments, though, the electrical connector fuse portion 135 may contact a different region of the first electrode 204 instead of or in addition to the fuse portion 230a. The side 133 of the electrical connector 228 also has a further portion 137 which is not in contact with the first electrode 204. As shown in FIG. 4, the further portion 137 may be recessed from the first electrode 204, so that there is a gap 236a between the further portion 137 of the electrical connector 228 and the indented portion 134a of the first electrode 204. In FIG. 4, the electrical connector 228 has a plurality of electrical connector fuse portions, and a plurality of further portions. However, only one of the electrical connector fuse portions 135 and only one of the further portions 137 are labelled, for clarity (and in other cases, the electrical connector 228 may have solely one electrical connector fuse portion and solely one further portion).

The electrical connector fuse portion 135 of the electrical connector 228 may for example act as a fuse portion of the electrical connector 228, and may have similar or the same features as the fuse portion 230a of the first electrode 204. In FIG. 4, the electrical connector fuse portion 135 of the electrical connector 228 and the fuse portion 230a of the first electrode 204 are mirror images of each other, but are otherwise the same in shape and size. However, in other cases, the electrical connector fuse portion 135 of the electrical connector 228 may have different features than the fuse portion 230a of the first electrode 204.

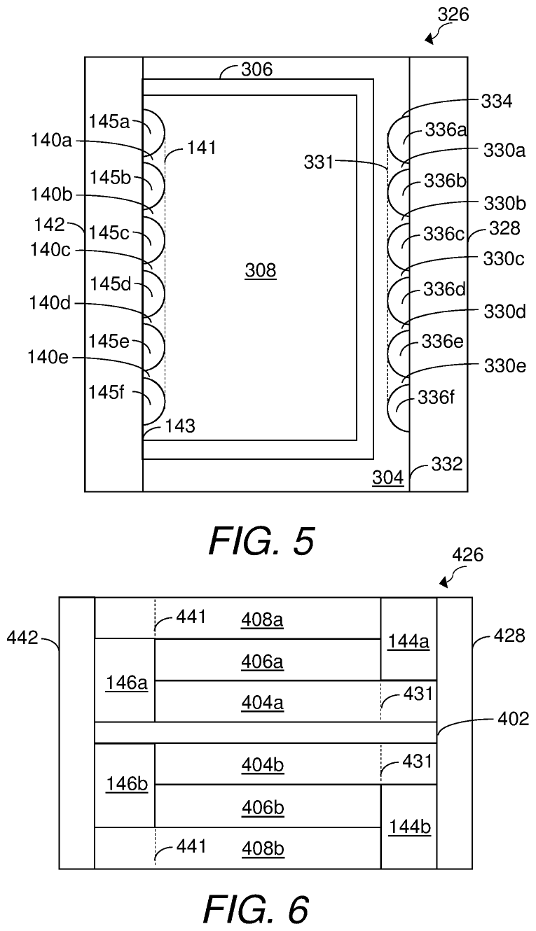

FIG. 5 shows a further example of a portion of an energy storage device 326 in plan view. The energy storage devices 126, 226 of FIGS. 3 and 4 are shown in plan view in a plane which corresponds with a surface of the first electrode 104, 204. However, in FIG. 5, the energy storage device 326 is shown in plan view in a plane corresponding to a surface of the second electrode 308. Features of FIG. 5 which are similar to corresponding features of FIGS. 1 and 3 are labelled with the same reference numeral but prepended with a “3” rather than a “1”. Corresponding descriptions are to be taken to apply.

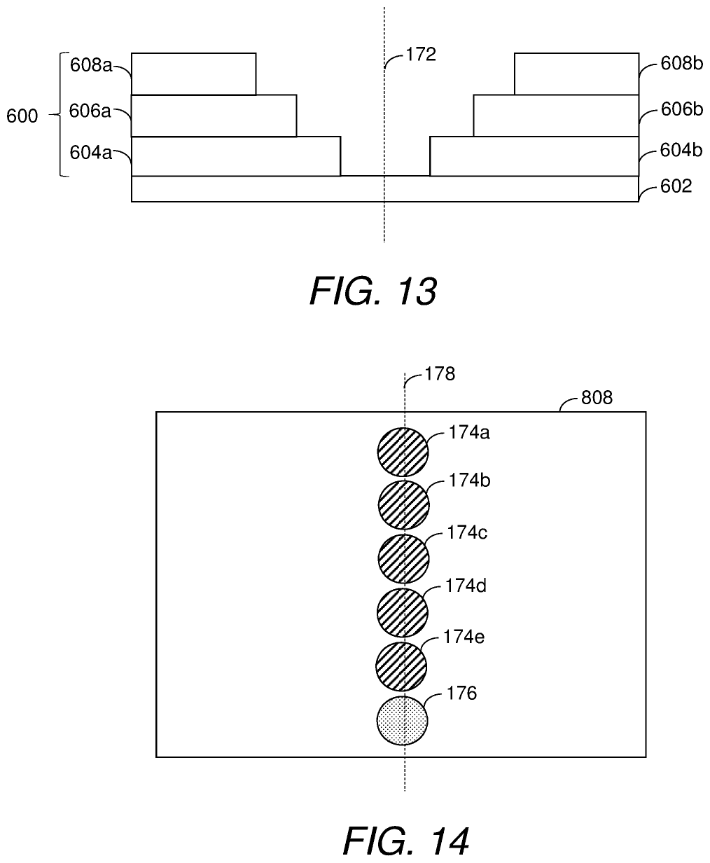

In FIG. 5, the first electrode 304 is closer to the substrate (which is obscured by the first electrode 304 in FIG. 5) than the second electrode 308. The electrolyte 306 is between the first electrode 304 and the second electrode 308. The first electrode 304 is larger than the electrolyte 306. The electrolyte 306 is larger than the second electrode 308. In this way, a stack including the first electrode 304, the electrolyte 306, and the second electrode 308 has a stepped edge, as shown in more detail in FIG. 13. However, in other embodiments, the relative sizes of the first electrode, the electrolyte and the second electrode may differ. For example, the first electrode, the electrolyte and the second electrode may have the same dimensions in plan view.

In FIG. 5, the first side 332 of the first electrode 304 is shown to the right of the Figure rather than to the left, as in FIG. 3. The first side 332 of the first electrode 304 includes the fuse portions 330 and is therefore non-planar. Each of the fuse portions 330 of the first electrode 304 may be considered first fuse portions. The electrical connector 328 may be considered a first electrical connector 328, which connects to the first electrode 304 by the first fuse portions 330.

However, in FIG. 5, the second electrode 308 also includes a fuse portion 140a, which may be referred to as a second fuse portion 140a. In FIG. 5, the second fuse portion 140a is the same as each of the first fuse portions 330. However, in other examples, the second fuse portion 140a may be different, e.g. in shape, size or other features, than at least one of the first fuse portions 330. A second electrical connector 142 is connected to the second electrode 308 by the second fuse portion 140a. The second electrical connector 142 may be similar to the first electrical connector 328 but connected to the second electrode 308 rather than the first electrode 304. In this way, the first and second electrical connectors 328, 142 may be used to connect the first and second electrodes 304, 308 to other electrical components such as an external circuit. This for example allows the energy storage device 326 to power an external circuit. The first and second electrical connectors 328, 142 are typically electrically insulated from each other to avoid short circuits occurring.

In the example of FIG. 5, the second electrode 308 includes a plurality of second fuse portions 140a-140e (collectively referred to with the reference numeral 140). However, in other examples, the second electrode 308 may include solely one second fuse portion, which may be different from or the same as the first fuse portions 330 of the first electrode 304. An extent of each of the second fuse portions 140 may be from a first side 143 of the second electrode 308 to a dashed line 141 in FIG. 5.

The second fuse portions 140 of FIG. 5 are similar to the first fuse portions 330. Hence, there is a gap 145a-145f (collectively referred to with the reference numeral 145) between neighbouring ones of the second fuse portions 140. In FIG. 5, these gaps 145 are for example a void or absence of the second electrode 308. In other embodiments, though, the gaps 145 may be filled with another material, such as an electrically insulating material.

In some embodiments, an energy storage device includes a plurality of cells. FIG. 6 shows an example of a portion of an energy storage device 426 including two cells. Features of FIG. 6 similar to corresponding features of FIG. 5 are labelled with the same reference numeral but prepended by a “4” and appended by the letter “a” when referring to a first cell, and appended by the letter “b” when referring to a second cell. Corresponding descriptions are to be taken to apply. FIG. 6 shows the portion of the energy storage device 426 in cross-section.

In FIG. 6, a first cell is located on a first side of a substrate 402. The first cell includes a first electrode 404a, an electrolyte 406a and a second electrode 408a. The first cell also includes first and second electrically insulating materials 144a, 146a.

The first electrically insulating material 144a insulates the first electrode 404a from the second electrode 408a, while revealing a side of the first electrode 404a for connection to the first electrical connector 428. The side of the first electrode 404a in contact with the first electrical connector 428 is the first side, which for example includes one or more fuse portions as illustrated in FIGS. 3 to 5. The first electrical connector 428 in FIG. 6 is therefore connected to the first electrode 404a of the first cell by the fuse portion or fuse portions of the first electrode 404a.

Similarly, the second electrically insulating material 146a insulates the first electrode 404a from the second electrode 408a, while revealing a side of the second electrode 408a for connection to the second electrical connector 442. The side of the second electrode 408a in contact with the second electrical connector 442 is the first side, which for example includes one or more fuse portions as illustrated in FIG. 5. The second electrical connector 442 in FIG. 6 is therefore connected to the second electrode 408a of the first cell by the fuse portion or fuse portions of the second electrode 408a.

A lateral extent of the fuse portions of the first electrode 404a is indicated with the dotted line 431 in FIG. 6. Similarly, a lateral extent of the fuse portions of the second electrode 408a is indicated with the dotted line 441 in FIG. 6. In FIG. 6, an extent of the fuse portions of the first electrode 404a aligns with an extent of the first electrically insulating material 144a, and an extent of the fuse portions of the second electrode 408a aligns with an extent of the second electrically insulating material 146a. However, in other embodiments, an extent the fuse portions of the first and/or second electrodes 404a, 408a may differ from this.

In some embodiments such as FIG. 6, the first electrical connector 428 extends along a first side of a stack including the first electrode 404a, electrolyte 406 and second electrode 408a of the first cell and the second electrical connector 442 extends along a second side of the stack, opposite to the first side.

In the example of FIG. 6, there is a second cell located on a second side of the substrate 402, opposite to a first side of the substrate 402 on which the first cell is arranged. In the example of FIG. 6, the first and second cells are otherwise identical to each other. Features of the second cell are labelled with the same reference numeral as corresponding features of the first cell, but appended by the letter “b” rather than the letter “a”. Corresponding descriptions are to be taken to apply. However, in other examples, cells on one side of a substrate may differ from cells on an opposite side of the substrate.

In some embodiments, a plurality of the first cell may be manufactured on the first side of the substrate 402 and a plurality of the second cell may be manufactured on the second side of the substrate 402, for example as part of a roll-to-roll manufacturing process. In such cases, the substrate 402 may be folded so as to stack a plurality of cells on top of each other. This therefore allows an energy storage device including a plurality of cells connected in parallel to be produced.

For example, the first electrode 404b of the second cell of the energy storage device 426 of FIG. 6 may be considered to correspond to a further first electrode including a further fuse portion. The first electrodes of the first and second cells 404a, 404b may overlap each other or be otherwise vertically aligned with each other. In such cases, the first electrical connector 428 may be connected to the first electrode 404a of the first cell by a fuse portion of the first electrode 404a of the first cell. The first electrical connector 428 may also be connected to the first electrode 404b of the second cell by a fuse portion of the first electrode 404b of the second cell. In this way, the first electrodes 404a, 404b of the first and second cells may be electrically connected to each other via the first electrical connector 428. Similarly, the second electrodes 408a, 408b of the first and second cells may be electrically connected to each other via the second electrical connector 442. The first and second electrical connectors 442, 428 may therefore provide contact points for terminals of the energy storage device 426. In this way, the first and second cells of the energy storage device 426 may be connected in parallel. For example, the first and second electrical connectors 428, 442 may provide contact points for negative and positive terminals of the energy storage device 426, respectively. The negative and positive terminals may be electrically connected across a load to power the load, thereby providing a multi-cell energy storage device. Such a multi-cell energy storage device may be manufactured in a simple manner, as described further with reference to FIGS. 8 to 13.

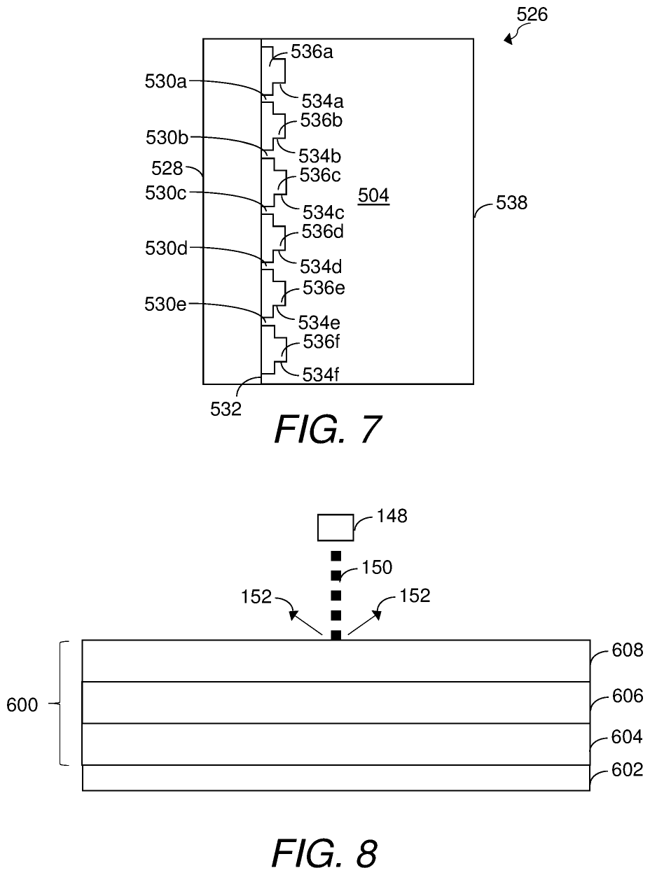

FIG. 7 is a schematic diagram showing a further example of a portion of an energy storage device 526. The energy storage device 526 of FIG. 7 is similar to that of FIG. 3. Similar features are labelled with the same reference numeral in FIG. 7 as in FIG. 3, but prepended by a “5”. Corresponding descriptions are to be taken to apply.

The energy storage device 526 of FIG. 7 is the same as that of FIG. 3 except for the shape of the fuse portions 530 and the indented portions 534 (and hence the gaps 536). In FIG. 3, the indented portions 534 are substantially C-shaped in plan view. In contrast, the indented portions 534 of FIG. 7 correspond to the shape of a cross divided in half along a vertical axis. In view of the shape of the indented portions 534, the fuse portions 530 have a constant thickness rather than narrowing towards the electrical connector 528 (as in FIG. 3). Nevertheless, the fuse portions 530 are narrower than other portions of the first electrode 504 so that the fuse portions 530 can function as a fuse in the event of a current exceeding a predetermined threshold current being passed through the first electrode 504.

FIG. 8 is a schematic diagram showing an example of removal of a portion of an electrode layer of a stack for an energy storage device. Methods in accordance with FIG. 8 may be used to provide the energy storage devices described herein (although it is to be appreciated that the energy storage devices described herein may alternatively be fabricated using different methods).

Features of FIG. 8 which are similar to corresponding features of FIG. 1 are labelled with the same reference numerals but prepended by a “6” rather than a “1”. In the method of FIG. 8, a stack 600 for a thin-film energy storage device is provided. In this example, the stack 600 is arranged on a substrate 602, although this is not necessary in all cases. The stack 600 and substrate 602 of FIG. 8 are similar to the stack 100 and substrate 102 of FIG. 1. It is to be appreciated that the widths of the elements of the stack are shown schematically and other widths are possible in other examples.

The first electrode layer 604, the electrolyte layer 606 and the second electrode layer 608 may be provided for example by a vapour deposition process such as physical vapour deposition (PVD) or chemical vapour deposition (CVD), or by a coating process for use with a roll-to-roll system such as slot die coating (sometimes referred to as slit coating). Each of these layers may be provided sequentially. However, in other examples, the substrate 602 may be provided partially assembled. For example, a stack including the first electrode layer 604, the electrolyte layer 606, and the second electrode layer 608 (or a subset of these layers) may already be arranged on the substrate 602 before the substrate 602 is provided. In other words, the substrate 602 may be provided with the stack 600 (or part of the stack 600) already arranged thereon.

Methods in accordance with FIG. 8 include removing a first portion of an electrode layer corresponding to a first region of the electrode layer. The first portion of the electrode layer may be removed during the formation of a groove through the stack 600. A groove is for example a channel, slot or trench that may be continuous or non-continuous. In some embodiments, a groove may be elongate. A groove may extend partway through the layers of a stack 600, or through all the layers of the stack 600 to expose an exposed portion of the substrate 602.

In FIG. 8, a first portion of the second electrode layer 608 is removed using laser ablation. Laser ablation may refer to the removal of material from the stack 600 using a laser-based process. The removal of material may include any one of multiple physical processes. For example, the removal of material may include (without limitation) any one or a combination of melting, melt-expulsion, vaporisation (or sublimation), photonic decomposition (single photon), photonic decomposition (multi-photon), mechanical shock, thermo-mechanical shock, other shock-based processes, surface plasma machining, and removal by evaporation (ablation). Laser ablation for example involves irradiating a surface of a layer (or layers) to be removed with a laser beam. This for example causes a portion of the layer (or layers) to be removed. The amount of a layer removed by laser ablation may be controlled by controlling properties of the laser beam such as the wavelength of the laser beam or a pulse length of a pulsed laser beam. Laser ablation typically allows removal of a precise quantity of a layer of the stack.

In FIG. 8, the laser ablation is performed using a laser ablation system 148, which typically includes a laser, and may include other optical elements to modify or otherwise tune properties of laser light produced by the laser ablation system 148. For example, a property of the laser light that may be modified may (without limitation) include one or more of a shape of the laser light, an intensity of the laser light, a power of the laser light, a focus position of the laser light, and a repetition frequency of the laser light. Optical elements of the laser ablation system 148 may include a neutral density filter for reducing a power and hence intensity of the laser light. Alternatively, the optical element may include a lens. For example, the lens may be configurable to modify a focus position of the laser.

The laser ablation system 148 is arranged to produce at least one first pulse of a laser beam 150. In FIG. 8, the laser ablation system 148 produces a series of first pulses of the laser beam 150, which are generated at regular intervals in time. However, in other embodiments, the first pulses may be generated intermittently or at irregular time intervals, or the laser ablation system 148 may instead produce solely one first pulse (such as a continuous pulse). Where the laser ablation system 148 is arranged to produce a continuous first pulse, a duration of the first pulse may be controlled to control an amount of the electrode layer (in this case, the second electrode layer 608), which is removed. The removed portion of the second electrode layer 608 is shown schematically in FIG. 8 using arrows 152.

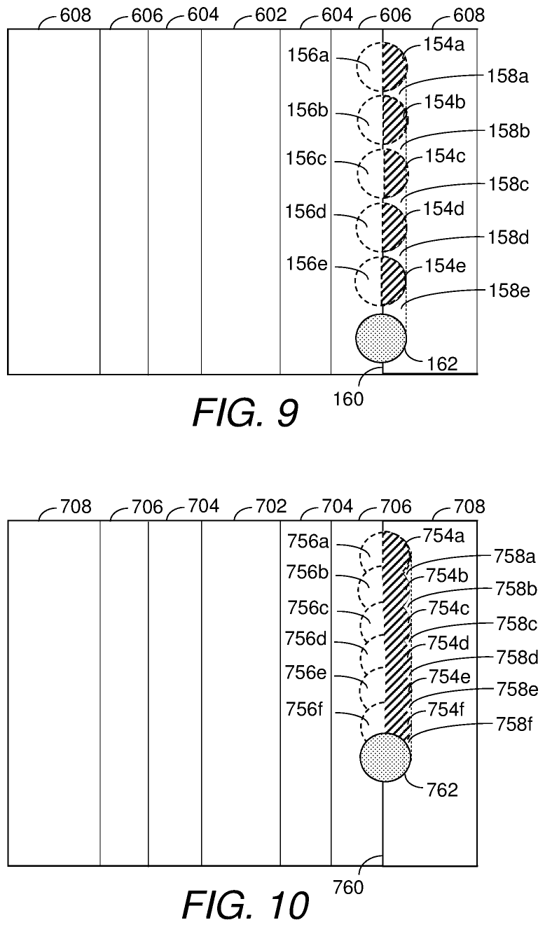

In some embodiments in accordance with FIG. 8, a first shape of the first portion of the electrode layer which is removed using the at least one first pulse of the laser beam 150 at least partly corresponds to a first cross-section of the laser beam 150 during the at least one first pulse. This is illustrated schematically in FIG. 9, which shows an example of removal of portions of the second electrode layer 608 of FIG. 8, in plan view.

In FIG. 9, a groove is formed through the first electrode layer 604, the electrolyte layer 606 and the second electrode layer 608. The groove exposes a surface of the substrate 602. The groove is narrowest in the first electrode layer 604, and gets gradually wider, in a stepped fashion, towards a mouth of the groove (i.e. in a direction away from the substrate 602). A groove with a stepped shape such as this is illustrated schematically in FIG. 13. The groove of FIG. 9 is formed using the laser ablation system 148 of FIG. 8.

Formation of the groove in the second electrode layer 608 includes removal of a first portion 154a of the second electrode layer 608. A second portion 154b of the second electrode layer 608 is removed using at least one second pulse of the laser beam 150 (in this example, a series of second pulses, although solely one second pulse is possible in other examples). The second portion 154b of the second electrode layer 608 corresponds to a second region of the second electrode layer 608. The second region is displaced from the first region to leave a remaining portion 158a of the second electrode layer 608 at least partly between the first region and the second region, as a fuse portion of the second electrode layer 608. The fuse portion may be similar to the fuse portion described herein with reference to FIGS. 3 to 5 and 7.

As will be appreciated from FIG. 8, in this example, the stack 600 is on a first side of the substrate 602. The laser beam 150 is directed towards the first side of the substrate 602 during the at least one first and second pulse. This may therefore simplify the laser ablation system 148. For example, the laser which produces the laser beam 150 may also be arranged at the first side of the substrate 602.

In the example of FIG. 9, the laser beam 150 has a substantially circular cross-section 162 during provision of the first and second pulses. A current position of the laser beam 150 is indicated using a dotted filling in FIG. 9. Previous positions of the laser beam 150 are indicated using dashed lines in FIG. 9, and labelled with the reference numerals 156a-156e.

The shape of the first and second portions 154a, 154b of the second electrode layer 608 that are removed by the laser beam 150 each have a shape at least partly corresponding to a cross-section of the laser beam 150 during the first and second pulses, respectively. In this example, the second electrode layer 608 has a substantially straight first side 160 before removal of the first and second portions 154a, 154b. However, by removing the first and second portions 154a, 154b of the second electrode layer 608, the first side 160 of the second electrode layer 608 is patterned so it is no longer straight. By patterning the first side 160 of the second electrode layer 608, the second electrode layer 608 is provided with fuse portions. The first and second portions 154a, 154b in FIG. 9 have a semicircular shape in plan view. The first and second portions 154a, 154b therefore have a shape at least partly corresponding with a shape of the cross-section of the laser beam 150 (which is circular in this example). In other embodiments, though, removed portions of an electrode layer (such as the first and second portions of the second electrode layer) may entirely correspond with the shape of the cross-section of the laser beam. For example, where the second electrode layer 608 is planar (e.g. before formation of a groove through the second electrode layer 608), a removed portion of the second electrode layer 608 may have the same shape as (or substantially the same shape as) a cross-section of a laser beam used to remove the removed portion.

In some embodiments in accordance with FIG. 9, a pulse timing scheme may be determined for use of the laser beam 150, for example to use the at least one first pulse for removing the first portion of the electrode layer and to use the at least one second pulse for removing the second portion of the electrode layer. The timing of the pulses of the laser beam 150 may then be controlled in accordance with the pulse timing scheme. A pulse timing scheme for example indicates times at which pulses of the laser beam 150 are to be generated, and durations of the generated pulses. For example, the pulse timing scheme may indicate that the laser beam 150 is to generate a plurality of pulses, which may form a sequence or other time-ordered series of pulses. The pulse timing scheme may also indicate times at which the pulses are to be produced, and may further indicate times at which the laser beam 150 is to be turned off so as not to produce a pulse. The pulse timing scheme may take into account an intended relative movement between the laser beam 150 and the stack 600. For example, the pulse timing scheme may indicate times at which pulses are to be generated, as well as an intended relative position between the laser beam 150 and the stack 600 during application of the pulses to the stack 600.

By controlling the time and duration of application of pulses of the laser beam 150, a shape of a removed portion of an electrode layer (such as the second electrode layer 608) can be controlled. In this way, a remaining portion of the electrode layer can be produced, as a fuse portion. A fuse rating of the fuse portion may depend on a shape and/or size of the fuse portion. Hence, a shape and/or size of the fuse portion (e.g. by controlling the first and second portions of the electrode layer removed by the laser beam 150) can be controlled so that the fuse portion has a predetermined fuse rating.

In FIG. 9, a plurality of portions of the second electrode layer 608 are removed, labelled with the reference numerals 154a-154e (collectively referred to with the reference numeral 154). In between two neighbouring removed portions of the second electrode layer 608 is a remaining portion of the second electrode layer 608, which acts as a fuse portion. The remaining portions are labelled with reference numerals 158a-158e (collectively referred to with the reference numeral 158). For example, the remaining portion 158a may be considered to be a first remaining portion. In this case, a third portion 154c of the second electrode layer 608 is removed using at least one third pulse of the laser beam 150. A third shape of the third portion 154c at least partly corresponds to a third cross-section of the laser beam 150 during the at least one third pulse. Hence, in this example, the third portion 154c is semi-circular, whereas the cross-section of the laser beam 150 is circular. The third region is displaced from the second region to leave a second remaining portion 158b at least partly between the second region and the third region as a second fuse portion of the second electrode layer 608.

As can be seen in FIG. 9, to produce the fuse portions of the second electrode layer 608, at least one of the laser beam 150 and the second electrode layer 608 may be moved relative to the other one. For example, in FIG. 9, the laser beam 150 is in a first position relative to the second electrode layer 608 to remove the first portion 154a of the second electrode layer 608 using the first pulses. After removal of the first portion 154a of the second electrode layer 608, the laser beam 150 is moved relative to the second electrode layer 608 to remove the second portion 154b of the second electrode layer 608. The laser beam 150 and the second electrode layer 608 may be moved relative to each other sequentially, in between removal of the removed portions of the second electrode layer 608. In this way, new portions of the second electrode layer 608 may be removed for each successive position of the laser beam 150 relative to the second electrode layer 608. This allows a series of portions of the second electrode layer 608 to be removed, as shown in FIG. 9, thereby forming a series of fuse portions of the second electrode layer 608 (which correspond to remaining portions 158 of the second electrode layer 608).

In some embodiments such as this, the laser beam 150 may be moved from one position to another while the stack 600 remains stationary. Conversely, the laser beam 150 may remain stationary while the stack 600 is moved from one position to another. In yet further examples, both of the laser beam 150 and the stack 600 may be moved, so as to alter a position of the laser beam 150 relative to a position of the stack 600. The stack 600 may be moved for example by moving the substrate 602 on which the stack 600 is arranged. For example, the substrate 602 may be arranged on rollers or on a moveable belt, in order to translate the substrate 602 (and hence the stack 600) beneath the laser beam 150, or beneath the laser ablation system 148. The laser beam 150 may be moved by altering an optical element of the laser ablation system 148, such as a mirror or other reflector, to deflect the laser beam 150 to alter a position at which the laser beam 150 intersects a surface of the stack 600. In such cases, a laser which produces the laser beam 150 may remain still. In other cases, though, the laser itself may be moved using any suitable actuator.

In the example of FIG. 9, the laser does not apply a laser beam to the stack 600 during movement of the laser beam 150 from the first position (to remove the first portion 154a of the second electrode layer 608) to the second position (to move the second portion 154b of the second electrode layer 608). However, in some cases, the laser may continue to apply a laser beam (which may be continuous or intermittent) during movement of one of the laser beam or the stack relative to the other of the laser beam or the stack. In such cases, a power of the laser beam may be altered during movement of the one of the laser beam or the stack relative to the other of the laser beam or the stack. For example, a power of the laser beam may be reduced during such relative movement, and increased while the laser beam is in a position at which a larger quantity of the electrode layer (such as the second electrode layer 608) is to be removed.

FIG. 10 shows a further example of removal of portions of an electrode layer, in plan view. Features of FIG. 10 that are similar to corresponding features of FIG. 9 are labelled with the same reference numerals but prepended by a “7”. Corresponding descriptions are to be taken to apply.

FIG. 10 is similar to FIG. 9. However, in FIG. 9, a first region of the stack 600 overlapped by the laser beam 150 during the first pulses is non-overlapping with a second region of the stack overlapped by the laser beam 150 during the second pulses. In contrast, in FIG. 10, the first region of the stack 700 overlapped by the laser beam during the first pulses partly overlaps a second region of the stack overlapped by the laser beam during the second pulses. The first region of the stack 700 for example includes the first region of the second electrode layer 708 which includes the first portion 754a which is removed by the first pulses. Similarly, the second region of the stack 700 for example includes the second region of the second electrode layer 708 which includes the second portion 754b which is removed by the second pulses.

Due to the different position of the laser beam 150 with respect to the stacks 600, 700 in FIGS. 9 and 10, the remaining portions 158, 758 of the second electrode layer 608, 708 are of a different shape and size in FIGS. 9 and 10. In FIG. 10, the first remaining portion 758a, which acts as a first fuse portion, is shallower or otherwise less protruding than the first remaining portion 158a of FIG. 9. Hence, it can be seen that controlling a position of the laser beam relative to the stack allows the shape and/or size of a fuse portion of an electrode layer of the stack to be controlled.

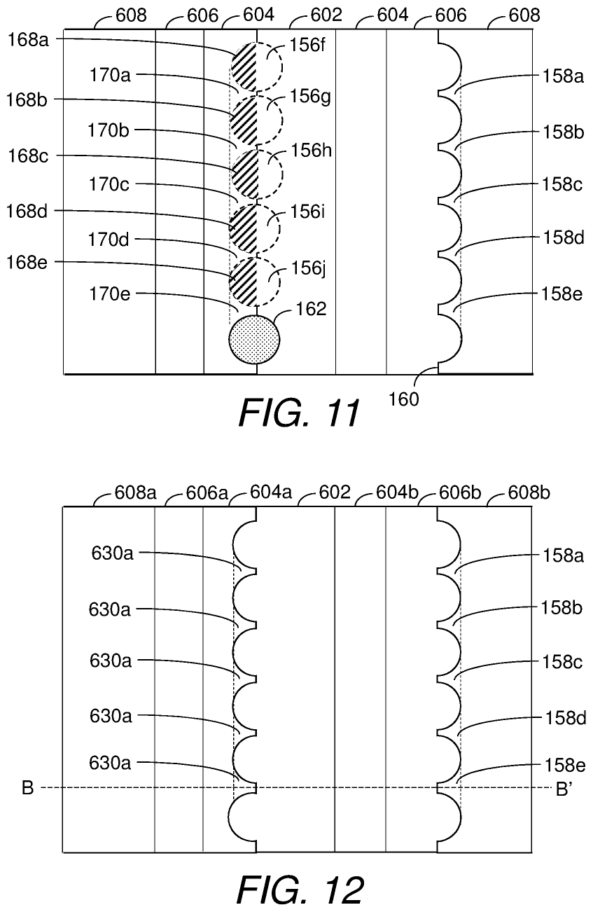

After formation of the fuse portions in the second electrode layer 608 of FIG. 9, to produce a second electrode layer 608 with a patterned first side 160, further processing may be applied to the stack 600. An example of such further processing is shown schematically in FIG. 11. Features of FIG. 11 that are the same as corresponding features of FIG. 9 are labelled with the same reference numerals. Corresponding descriptions are to be taken to apply.

In FIG. 11, the laser beam is used to apply laser pulses to the stack 600 to remove a series of portions of the first electrode layer 604. A cross-section 162 of the laser in a current position is indicated in FIG. 11. Previous cross-sections of the laser are labelled with the reference numerals 156f-156j.

The removed portions of the first electrode layer 604 are labelled with the reference numerals 168a-168e, and are collectively referred to with the reference numeral 168. The same pulse timing sequence may be used to remove the portions of the first electrode layer 604 as that used to remove the portions of the second electrode layer 608. However, in other examples, different pulse timing schemes may be used for each. In such cases, a size, shape or number of removed portions of the first electrode layer 604 may be different from that of the second electrode layer 608. Similarly, a size, shape or number of fuse portions of the first electrode layer 604 may be different from that of the second electrode layer 608.

Removal of the first electrode layer 604 creates a plurality of remaining portions of the first electrode layer 604, which are labelled with reference numerals 170a-170e (collectively referred to with the reference numeral 170). As in FIG. 9, these remaining portions 170 correspond to fuse portions of the first electrode layer 604.

In the example of FIG. 11, a side of the first electrode layer 604 closest to the first side 160 of the second electrode layer 608 is ablated to form the fuse portions. In this way, a groove is created through the stack, with a patterned portion in the second electrode layer 608 (on a right side of the groove in FIG. 11) and a patterned portion in the first electrode layer 608 (on a left side of the groove in FIG. 11). However, in other examples, a groove may be non-planar in only one, or neither, of the electrode layers (rather than both). Alternatively, patterning of both the first and second electrode layers 604, 608 may be performed on the same side of the groove, rather than on opposite sides.

FIG. 12 is a schematic diagram that shows an example of a stack 600 that may be fabricated by completing the laser ablation illustrated in FIG. 11.

Due to formation of the groove in the stack 600, the first electrode layer 604 includes a first section 604a and a second section 604b, separated by the groove. Similarly, the electrolyte layer 606 includes a first section 606a and a second section 606b, separated by the groove. The second electrode layer 608 also includes a first section 608a and a second section 608b, separated by the groove. The removed portions of the first and second electrode layers 604, 608 are between the first and second sections of the first electrode layer 604a, 406b and the second electrode layer 608a, 608b.

In FIG. 12, a fuse portion of the second electrode layer 608 (which for example corresponds to a remaining portion of the second electrode layer 608, such as any of the remaining portions 158) has a length which is less than a distance between the first and second sections 608a, 608b of the second electrode layer 608. In this way, the first section 608a of the second electrode layer 608 is not connected to the second section 608b of the second electrode layer 608 by the fuse portion. Similarly, in FIG. 12, a length of remaining portions 168 of the first electrode layer 604 are also less than a distance between the first and second sections 604a, 604b of the first electrode layer 604.

The stack 600 of FIG. 12 is shown in cross-section, along the line B-B′, in FIG. 13. The stack 600 may be cut through, in a direction 172 substantially perpendicular to a plane of a surface of the substrate 602, to provide an intermediate structure for the manufacture of a thin-film energy storage device. In FIG. 12, the stack 600 is cut in a direction 172 which extends along a central axis of the groove, in a direction substantially perpendicular to a plane of a surface of the substrate 602. A direction may be considered substantially perpendicular to a plane where the direction is precisely perpendicular to the plane or whether the direction is approximately perpendicular to the plane, such as within measurement uncertainties, or within 20%, 15%, 10% or 5% of perpendicular. However, in other embodiments, the direction 172 may be off-centre with respect to the groove, or the stack 600 may be cut through at an oblique angle with respect to the plane of the surface of the substrate 602, which is for example an angle which is less than 90 degrees.

Such an intermediate structure for example includes a portion of the substrate 602 and an electrode formed from an electrode layer of the stack 600 (such as one of the first and second electrode layers 604, 608). Such an electrode for example includes a fuse portion as a protrusion of a side of the electrode, which protrudes in a direction substantially parallel to a plane of a surface of the portion of the substrate. Although not visible from FIG. 13 (which is in cross-section), this will be appreciated from FIG. 12, which shows the stack 600 of FIG. 13 in plan view.

In the embodiments of FIGS. 9 to 13, a relatively wide groove is formed in the stack. In this way, first and second sections of the first and second electrode layers are separated from each other prior to cutting through the stack to form the intermediate structure. However, in other examples, the first and second sections of the first and second electrode layers may remain partially in contact with each other prior to cutting through the stack to form the intermediate structure. FIG. 14 shows such an example.

In FIG. 14, a plurality of perforations 174a-174e (collectively referred to with the reference numeral 174) are formed in a second electrode layer 808 (which may be the same as or similar to the second electrode layer of other examples herein). For example, the second electrode layer 808 includes a first perforation 174a corresponding to a first region of the second electrode layer 808 and a second perforation 174b corresponding to a second region of the second electrode layer 808. In FIG. 14, the first and second perforations 174a, 174b are substantially the same size and shape as each other, as the laser beam (with a cross-section 176) has substantially the same cross-section and power during formation of the first and second perforations 174a, 174b. However, this need not be the case.

The use of the laser beam may be as described with reference to FIGS. 8 and 9. The cross-section 176 of the laser beam, to form a further perforation in the second electrode layer 808, is shown schematically in FIG. 14. For example, the laser beam may be controlled to form the first and second perforations 174a, 174b each with at least one of a predetermined size or pitch.

The second electrode layer 808 may subsequently be cut into two, to provide two separate sections of the second electrode layer 808, which would otherwise be joined along an axis 178. The axis 178 along which the second electrode layer 808 may be cut for example corresponds to an intersection between a plane perpendicular to a plane of a surface of a substrate on which a stack including the second electrode layer 808 is arranged, and the surface itself. The axis 178 for example passes through the perforations 174 of the second electrode layer 808. In this case, the perforations 174 are aligned along a central axis, and the axis 178 corresponds with the central axis of the perforations 174. However, in other examples, the axis 178 may be off-centre with respect to the perforations 174.

The portion of the second electrode layer 808 which remains after removal of the first and second regions of the second electrode layer 808 (and formation of the first and second perforations 174, 174b) for example corresponds to a fuse portion. In the example of FIG. 14, the fuse portion connects the first section of the second electrode layer 808 to the second section of the second electrode layer 808. However, after cutting of the stack, the fuse portion may remain as a protrusion of a side of the second electrode layer 808.

While FIG. 14 illustrates perforations in a second electrode layer, other examples may include forming perforations in a first electrode layer, instead of or as well as formation of perforations in the second electrode layer.

The above examples are to be understood as illustrative examples. Further examples are envisaged. In examples described herein, the first electrode is a cathode, which is closer to the substrate than the second electrode (an anode). However, in other examples, the first electrode (which for example includes a fuse portion) may be further from the substrate than the second electrode. In such cases, the first electrode may be an anode and the second electrode may be a cathode. The fuse portion of the first electrode in these examples may be narrower than a portion of the first electrode which overlaps the second electrode. However, the first electrode may otherwise be similar to the first electrode described above (other than its position with respect to the second electrode and hence its function as an anode rather than a cathode).

In examples such as FIG. 4, in which the electrical connector includes an electrical connector fuse portion, the electrical connector fuse portion may be formed in a similar manner to formation of the fuse portion of the electrode layer, and may be formed at the same time as, or during formation, of the fuse portion of the electrode layer. For example, a first portion of the electrical connector may be removed using the at least one first pulse of the laser beam which is used to remove the first portion of the electrode layer (although a different pulse may be used in other examples). Similarly, a second portion of the electrical connector may be removed using the at least one second pulse of the laser beam which is used to remove the second portion of the electrode layer (although a different pulse may be used in other examples). This for example leaves a remaining portion of the electrical connector, which corresponds to the electrical connector fuse portion. The remaining portion is for example at least partly between a first region of the electrical connector corresponding to the first portion of the electrical connector, which is removed, and a second region of the electrical connector corresponding to the second portion of the electrical connector, which is also removed.

In such cases, the first cross-section of the laser beam may overlap the first regions of both the electrode layer and the electrical connector. Similarly, the second cross-section of the laser beam may overlap the second regions of both the electrode layer and the electrical connector. In this way, a combined first portion of the electrode layer and the electrical connector, which is removed by the at least one first pulse, may have a shape which corresponds to the first cross-section of the laser beam. Similarly, a combined second portion of the electrode layer and the electrical connector, which is removed by the at least one second pulse, may have a shape which corresponds to the second cross-section of the laser beam. For example, as shown in FIG. 4, each of the combined first portion and the combined second portion may have a circular shape in plan view, which corresponds to a circular first and second cross-section of the laser beam, respectively.

It is to be appreciated that, in yet further examples, the electrical connector may include an electrical connector fuse portion and the electrode layer may not include a fuse portion. In such cases, a side of the electrode layer closest to the electrical connector fuse portion may be planar.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A thin-film energy storage device comprising:
a substrate;
a first electrode comprising a fuse portion;
a second electrode;
an electrolyte between the first electrode and the second electrode; and
an electrical connector, different from the first electrode, connected to the first electrode by the fuse portion.

2. The thin-film energy storage device of claim 1, wherein one of:
the first electrode is closer to the substrate than the second electrode, and the fuse portion is narrower than a portion of the first electrode overlapped by the second electrode; or
the first electrode is further from the substrate than the second electrode, and the fuse portion is narrower than a portion of the first electrode which overlaps the second electrode.

3. The thin-film energy storage device of claim 1 or claim 2, wherein the fuse portion is a protrusion of a first side of the first electrode.

4. The thin-film energy storage device of claim 3, wherein the protrusion protrudes in a direction parallel to a plane of a surface of the substrate.

5. The thin-film energy storage device of claim 3, wherein a first portion of the protrusion is narrower than a second portion of the protrusion further from the electrical connector than the first portion of the protrusion.

6. The thin-film energy storage device of claim 3, wherein the electrical connector contacts the fuse portion without contacting an indented portion of the first side of the first electrode.

7. The thin-film energy storage device of claim 6, wherein the indented portion of the first side of the first electrode is C-shaped, V-shaped, or elongate in plan view.

8. The thin-film energy storage device of claim 3, wherein a side of the electrical connector comprises an electrical connector fuse portion which is in contact with the fuse portion of the first electrode and a further portion not in contact with the first electrode.

9. The thin-film energy storage device of claim 8, wherein the electrical connector fuse portion is a protrusion of the side of the electrical connector.

10. The thin-film energy storage device of claim 3, wherein a second side of the first electrode, opposite to the first side, is planar.

11. The thin-film energy storage device of claim 1, comprising a further first electrode comprising a further fuse portion, the further first electrode overlapping the first electrode,
wherein the electrical connector is connected to the further first electrode by the further fuse portion.

12. The thin-film energy storage device of claim 1, wherein the fuse portion is a first fuse portion, the electrical connector is a first electrical connector, the second electrode comprises a second fuse portion, and the thin-film energy storage device comprises a second electrical connector connected to the second electrode by the second fuse portion.

13. The thin-film energy storage device of claim 12, comprising a stack comprising the first electrode, the second electrode and the electrolyte, wherein
the first electrical connector extends along a first side of the stack; and
the second electrical connector extends along a second side of the stack, opposite to the first side of the stack.

14. The thin-film energy storage device of claim 1, wherein the first electrode comprises a plurality of fuse portions each having the same shape as each other, the plurality of fuse portions comprising the fuse portion.

15. A method comprising:
providing a stack for a thin-film energy storage device, the stack comprising an electrode layer;
removing a first portion of the electrode layer corresponding to a first region of the electrode layer, using at least one first pulse of a laser beam, a first shape of the first portion at least partly corresponding to a first cross-section of the laser beam during the at least one first pulse; and
removing a second portion of the electrode layer corresponding to a second region of the electrode layer, using at least one second pulse of the laser beam, a second shape of the second portion at least partly corresponding to a second cross-section of the laser beam during the at least one second pulse, the second region of the electrode layer displaced from the first region of the electrode layer to leave a remaining portion of the electrode layer at least partly between the first region of the electrode layer and the second region of the electrode layer as a fuse portion of the electrode layer.

16. The method of claim 15, comprising:
arranging an electrical connector in contact with the electrode layer;
removing a first portion of the electrical connector corresponding to a first region of the electrical connector, using the at least one first pulse of the laser beam, during removing the first portion of the electrode layer; and
removing a second portion of the electrical connector corresponding to a second region of the electrical connector, using the at least one second pulse of the laser beam, during removing the second portion of the electrode layer, the second region of the electrical connector displaced from the first region of the electrical connector to leave a remaining portion of the electrical connector at least partly between the first region of the electrical connector and the second region of the electrical connector,
wherein the remaining portion of the electrical connector is in contact with the fuse portion of the electrode layer.

17. The method of claim 16, wherein the electrical connector comprises a different material than the electrode layer.

18. The method of claim 15, wherein, after removing the first portion of the electrode layer and the second portion of the electrode layer, the electrode layer comprises:
a first perforation corresponding to the first region of the electrode layer; and
a second perforation corresponding to the second region of the electrode layer.

19. The method of claim 18, wherein the first perforation and the second perforation are at least one of: the same size as each other, or the same shape as each other.

20. The method of claim 18, comprising controlling the laser beam to form the first perforation and the second perforation each with least one of: a predetermined size or a predetermined pitch.

21. The method of claim 15, wherein the remaining portion of the electrode layer is a first remaining portion, the fuse portion is a first fuse portion, and the method comprises:
removing a third portion of the electrode layer corresponding to a third region of the electrode layer, using at least one third pulse of the laser beam, a third shape of the third portion at least partly corresponding to a third cross-section of the laser beam during the at least one third pulse, the third region displaced from the second region to leave a second remaining portion at least partly between the second region and the third region as a second fuse portion of the electrode layer.

22. The method of claim 15, wherein the electrode layer comprises a first section and a second section, the first region of the electrode layer between the first section and the second section, and the second region of the electrode layer between the first section and the second section,
wherein the fuse portion of the electrode layer connects the first section of the electrode layer to the second section of the electrode layer.

23. The method of claim 15, wherein the electrode layer comprises a first section and a second section, the first region of the electrode layer between the first section and the second section, and the second region of the electrode layer between the first section and the second section,
wherein a length of the fuse portion of the electrode layer is less than a distance between the first section and the second section such that the first section of the electrode layer is not connected to the second section of the electrode layer by the fuse portion.

24. The method of claim 15, wherein the stack is on a substrate, and the method comprises:
cutting through the stack in a direction perpendicular to a plane of a surface of the substrate to provide an intermediate structure for manufacture of the thin-film energy storage device.

25. The method of claim 24, wherein the intermediate structure comprises:
a portion of the substrate; and
an electrode formed from the electrode layer, the electrode comprising the fuse portion as a protrusion of a side of the electrode, wherein the protrusion protrudes in a direction parallel to a plane of a surface of the portion of the substrate.

26. The method of claim 15, wherein the fuse portion narrows in shape.

27. The method of claim 15, wherein the stack is on a first side of a substrate and the laser beam is directed towards the first side of the substrate during the at least one first pulse and the at least one second pulse.

28. The method of claim 15, comprising:
moving one of the laser beam and the electrode layer relative to the other of the laser beam and the electrode layer after applying the at least one first laser pulse of the laser beam to the electrode layer and before applying the at least one second laser pulse of the laser beam to the electrode layer.

29. The method of claim 15, wherein the first cross-section of the laser beam overlaps a first region of the stack during the at least one first pulse, and the second cross-section of the laser beam overlaps a second region of the stack during the at least one second pulse, the second region of the stack partly overlapping the first region of the stack.

30. The method of claim 15, comprising:
determining a pulse timing scheme for using the at least one first pulse of the laser beam for removing the first portion of the electrode layer and the at least one second pulse of the laser beam for removing the second portion of the electrode layer, without removing the remaining portion of the electrode layer; and
controlling a timing of the at least one first pulse of the laser beam and the at least one second pulse of the laser beam in accordance with the pulse timing scheme.

31. The method of claim 15, comprising controlling the laser beam to remove the first portion of the electrode layer and the second portion of the electrode layer so that the fuse portion has a predetermined fuse rating.

32. A thin-film energy storage device formed by the method of claim 15.
